(19) United States
(12) Patent Application Publication
(10) Pub. No.: US 2021/0272581 A1
(43) Pub. Date: Sep. 2, 2021

(54) WASHING AND/OR DRYING MACHINE AND A METHOD OF DETERMINING LAUNDRY MATERIAL

(71) Applicant: Vestel Elektronik Sanayi ve Ticaret A.S., Manisa (TR)

(72) Inventors: Onur ULUAG, Manisa (TR); Kagan BAKANOGLU, Manisa (TR)

(21) Appl. No.: 17/272,230

(22) PCT Filed: Aug. 29, 2018
(86) PCT No.: PCT/EP2018/073241

§ 371 Date: Feb. 26, 2021

(51) Int. Cl. G10L 25/51; H04R 1/02; H04R 1/08; H04R 3/00; G10K 15/04; D06F 33/32

(52) U.S. Cl. CPC G10L 25/51; H04R 1/028; H04R 1/08; D06F 2105/52; G10K 15/04; D06F 33/32; H04R 3/00

(57) ABSTRACT

Washing and/or drying machine has a drum for receiving laundry to be washed and/or dried. A sound generator generates sound which is directed at the laundry. A sound receiver receives sound generated by the sound generator and that is reflected and/or transmitted by said laundry, and outputs corresponding output signals. A controller controls the sound generator to generate sound and receives output signals from the or each sound receiver. The controller determines the laundry material in accordance with the acoustic properties of the laundry based on at least the output signals received from the or each sound receiver.

### TECHNICAL FIELD

The present disclosure relates to a washing and/or drying machine and a method of determining laundry material.

### BACKGROUND

Washing machines are used for washing laundry items, such as clothes, bed linen, towels, etc. Likewise, drying machines, such as tumble dryers, are used to dry laundry items. Some machines provide both a washing function and a drying function.

Typically a user can select a suitable washing program and/or a suitable drying program for the specific laundry items via an interface on the machine. The interface usually includes a number of control knobs and/or buttons. There are typically a number of programs from which the user can select. Commonly, there are at least different programs for different types of laundry material, such as cotton, wool, synthetics, silk, etc.

### SUMMARY

According to a first aspect disclosed herein, there is provided a washing and/or drying machine, the machine comprising:

a drum for receiving laundry to be washed and/or dried;

a sound generator for generating sound to be directed at laundry;

a sound receiver arranged to receive sound generated by the sound generator and that is reflected and/or transmitted by said laundry and to output corresponding output signals; and

a controller constructed and arranged to control the sound generator to generate sound, to receive output signals from the sound receiver, and to determine the laundry material in accordance with the acoustic properties of the laundry based on at least the output signals received from the sound receiver.

The acoustic properties of the laundry may include the speed of sound in the laundry, which can be determined based on suitable processing of the output signals from the or each sound receiver.

In an example, the sound generator is arranged to direct the laundry is loaded into the drum.

In an example, the sound generator and the sound receiver are located in a door casing of the machine which defines the main entrance to the drum.

In an example, the machine comprises a sound generator and a first sound receiver located at a first side of the machine and a second sound receiver located at a second side of the machine, the first sound receiver being arranged to receive sound that has been generated by the sound generator and reflected by an exterior surface of laundry located towards the first side of the machine, the second sound receiver being arranged to receive sound that has been generated by the sound generator and transmitted through said laundry.

In an example, the first sound receiver is arranged to receive sound that has been generated by the sound generator and reflected by an interior surface of laundry located towards the second side of the machine.

In an example, the machine comprises a second sound generator located at the second side of the machine, wherein the second sound receiver is arranged to receive sound that has been generated by the second sound generator and externally reflected in use by a second side of said laundry which is towards the second side of the machine, and wherein the controller is arranged to determine the laundry material from the speed of sound in the laundry as calculated from the time of flight and the speed of sound from the first sound receiver to the first side of said laundry, the time of flight and the speed of sound from the second sound receiver to the second side of said laundry, the time of flight of sound from the first or second sound generator to the second or first sound receiver respectively and the distance between said sound generator and said sound receiver.

In an example, the sound receiver is arranged to provide a measure of the amplitude of received sound, and the controller is configured to determine the density of said laundry in accordance with the amplitude of received sound and the speed of sound in said laundry.

In an example, the machine comprises data storage which stores data concerning different types of laundry material and acoustic properties of the different types of laundry material.

In an example, the data concerning different types of laundry material and acoustic properties of the different types of laundry material comprises different densities of laundry material and the corresponding speed of sound in said laundry material.

In an example, the controller is configured to cause the machine to operate a program based at least in part on the determined laundry material.

According to a second aspect disclosed herein, there is provided a method of determining a type of laundry material, the method comprising:

directing sound at an item of laundry as the laundry is loaded into a washing and/or drying machine;

receiving sound that is transmitted and/or reflected by the item of laundry; and

determining the laundry material of the item of laundry in accordance with the acoustic properties of the laundry based on the received sound.

In an example:

the directing sound comprises directing sound towards a first side of the item of laundry; and

the receiving sound comprises: receiving at the first side of the item of laundry sound that has been reflected by an exterior surface of laundry at the first side of the item laundry; and receiving at a second side of the item of laundry sound that has been transmitted through the laundry.

In an example, the receiving sound comprises receiving at the first side of the item of laundry sound that has been reflected by an interior surface of the laundry located towards the second side of the item of laundry.

In an example, the determining the laundry material of the item of laundry comprises determining the laundry material of the item of laundry based on the amplitude of received sound.

In an example, the acoustic properties of the laundry comprise the speed of 2sound in the laundry.

### BRIEF DESCRIPTION OF THE DRAWINGS

To assist understanding of the present disclosure and to show how embodiments may be put into effect, reference is made by way of example to the accompanying drawings in which:

FIG. 1 shows schematically an example of a washing machine according to an embodiment of the present disclosure; and

FIG. 2 shows schematically sound being transmitted and reflected by laundry.

### DETAILED DESCRIPTION

With known washing and/or drying machines, the user has to manually select a washing or and/or drying program from a number of available programs which are typically stored locally by the machine. For example, for delicate items, such as those made of silk or wool, a program may be selected that runs at low temperatures; whereas for synthetics a program that runs at a higher temperature may be selected; and for cottons, a program that runs at an even higher temperature may be selected. However, this places the onus on the user to read and understand washing or drying instructions associated with each laundry item to be washed or dried. This is time and labour intensive and also prone to user error. Moreover, some laundry items may not have washing or drying instructions. Therefore a user may select an incorrect or non-optimal washing or drying program for the type or number of laundry items placed in the machine. This can lead to wasted energy and/or damaged laundry items.

Examples of the present disclosure provide a washing and/or drying machine that can determine the laundry material automatically, avoiding the user having to read and interpret washing or drying instructions (which may not even be present on some laundry items). The washing and/or drying machine can then operate a program in accordance with the determined laundry material, or at least request the user to select a program from a subset of programs that are appropriate for the determined laundry material. In some examples, the machine may provide a warning to the user if laundry items of different and possibly incompatible materials are present. In some examples, the machine may obtain an estimate of the weight of the laundry item based on the determined laundry material and a determined shape of the laundry item. In such a case, the machine may select a program appropriate for the total weight of laundry loaded into the machine and/or issue a warning to the user if the total weight of laundry exceeds some maximum threshold.

Some specific examples of the present disclosure will now be described with reference to the drawings. The following description is mainly given in terms of the machine being a washing machine for washing laundry items. However, it will be appreciated that many of the same principles are also applicable to drying machines, including for example tumble dryers, and to combined washing and drying machines.

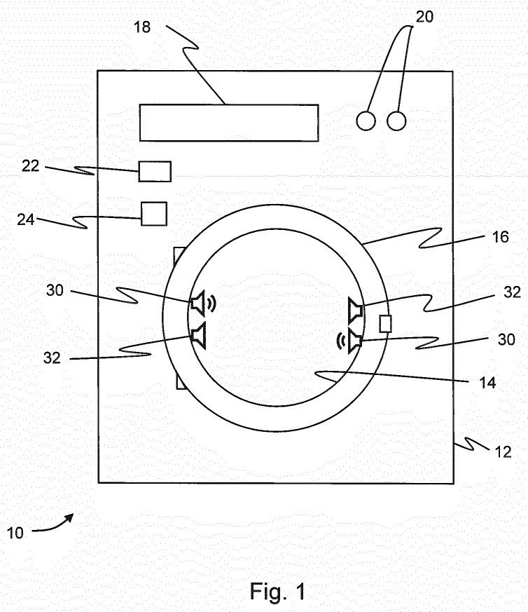

Referring to FIG. 1, this shows schematically an example of a washing machine 10. The machine 10 has an external case or housing 12. The machine 10 has a basket or drum 14, into which laundry items are loaded by a user in use. The drum 14 is typically rotatable. The machine 10 has a door 16 which can be opened to allow access to the drum 14 and closed during a washing cycle. The example machine 10 is a front-loading machine, so the door 16 is located at the front of the machine 10. In other examples, the machine 10 is a top-loading machine, so the door 16 is located at the top of the machine 10. The machine 10 further has a display/control panel 18 and one or more control knobs or buttons 20 which enable the machine 10 to be operated and allow the user to select specific washing or drying programs, set different temperatures, etc. The machine 10 further has a controller 22, which may comprise one or more processors, etc. The machine 10 also has data storage 24 for electronic storage of data.

The machine 10 also has at least one sound generator 30 for generating sound and at least one sound receiver 32 for receiving sound generated by the sound generator 30 (optionally after having been reflected and/or having been transmitted through laundry, as will be discussed further below).

In the example shown, the machine 10 has a first sound generator 30 and a first sound receiver 32 at or towards one side of the machine 10 (in this example, the left side when viewing the machine 10 from the front, as in FIG. 1). In some examples a first sound generator 30 and a first sound receiver 32 on one side of the machine 10 is sufficient for the present method. In other examples, the machine 10 has a second sound receiver 32 at or towards the opposite side of the machine 10 (the right side when viewing the machine 10 from the front, as in FIG. 1). That is, the first sound generator 30 and first sound receiver 32 are on one side of the drum 14 and the second sound receiver 32 is on the opposite side of the drum 14 in such examples. In yet other examples there may be a second sound generator 30 on the other side of the machine 10, that is, on the same side as the second sound receiver 32. There may be yet further sound generators and/or yet further sound receivers positioned at other locations around the machine 10, as will be discussed below.

The sound generator(s) 30 and sound receiver(s) 32 in an example are located in the vicinity of the door casing, i.e. the part of the machine 10 that defines the main entrance or tunnel to the drum 14 through which laundry items are passed so as to load the laundry into and unload the laundry from the drum 14. The sound generator(s) 30 and sound receiver(s) 32 may be located in the door casing and directed towards the entrance or tunnel through which laundry items are passed. In this example, the type of laundry material can be determined for each item of laundry as it is being loaded through the door casing into the machine 10.

In an example, the sound generator(s) 30 are arranged to generate ultrasonic sound, that is sound above a frequency of around 20 kHz or so. The sound generator(s) 30 may be for example piezoelectric transducers, which may be for example formed of a piezoelectric ceramic, a piezoelectric polymer, etc. The sound generator(s) 30 may be arranged so that their acoustic impedance matches closely with the acoustic impedance of air. This helps to reduce losses as sound is generated by the sound generator(s) 30.

In an example, the sound receiver(s) 32 are arranged to receive sound generated by the sound generator(s) 30 and to output a corresponding signal. The sound receiver(s) 32 may be for example piezoelectric transducers, which may be formed of a piezoelectric ceramic, a piezoelectric polymer, etc. The sound receiver(s) 32 may of the same type as the sound generator(s) 30, which provides for good reception and transducing of the sound generated by the sound generator(s) 30.

The sound generator(s) 30 and sound receiver(s) 32 may be provided by separate devices. However, in some examples, especially where a sound generator 30 and a sound receiver 32 are to be located close to each other, they may be provided by a single device which can be controlled as necessary to operate as a sound generator or a sound receiver as required during different phases of operation.

The controller 22 controls operation of the sound generator(s) 30, in particular sending necessary drive signals to the sound generator(s) 30 to cause them to operate to generate sound when required and as discussed further herein. If there are plural sound generators 30, in some examples the controller 22 can control each sound generator 30 independently. The controller 22 also receives the output signals from the or each sound receiver 32. The controller 22 further has a clock or timer, or access to a clock or timer, and operates with a high enough clock speed and sufficient accuracy and sensitivity to be able to control the sound generator(s) 30 and process the output signals from the or each sound receiver 32 correctly, as discussed further below. There may also be other circuity (not shown), such as amplifiers, filters, etc., for amplifying and filtering if necessary the signals sent to the sound generator(s) 30 and received from the sound receiver(s) 32.

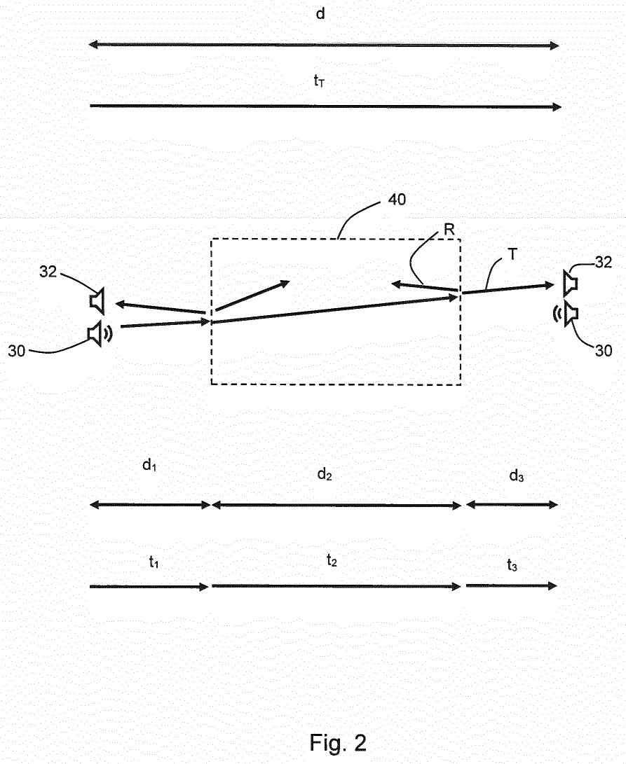

FIG. 2 shows schematically sound being transmitted and reflected by laundry 40. The laundry is a single item of laundry 40. The example shown has a first sound generator 30 and a first sound receiver 32 on one side of the laundry item 40 and a second sound generator 30 and a second sound receiver 32 on the other, opposite side of the laundry item 40. This corresponds to the specific example shown in FIG. 1, where the first sound generator 30 and the first sound receiver 32 are in the door casing at one side of the entrance tunnel to the drum 14 and the second sound generator 30 and the second sound receiver 32 are in the door casing at the opposite side of the entrance tunnel to the drum 14. A discussion of a first example will now be given in respect of such an arrangement. Other examples, which have different numbers of and arrangements for the generator(s) 30 and the second sound receiver(s) 32, will be discussed further below. In all of the examples, sound generated by a sound generator 30 is directed at laundry 40, and a sound receiver 32 receives sound, which may be reflected and/or transmitted by the laundry 40. The sound signals are processed to enable a determination to be made of the acoustic properties of the laundry and therefore a determination of the type of laundry, including specifically the fabric type of the laundry. In an example, a determination of the type of laundry is made based on the speed of sound through the laundry.

In the first example, where there are both sound generators 30 and sound receivers 32 on opposite sides of the laundry 40, whilst plural sound generators 30 and sound receivers 32 are required, the processing is more straightforward. In particular and considering FIG. 2, the following are defined:
V_{A}=speed of sound in air (known, from calibration or from air temperature and pressure)
V_{L}=speed of sound in laundry (to be obtained p0 d=total distance from sound generator 30 to sound receiver 32 on other side of laundry 40 (known)
t_{T}=total time for sound to travel from sound generator 30, through laundry 40, to sound receiver 32 on other side of laundry 40 (measure)
t₁=time for sound from sound generator 30 to laundry (measure by measuring time for sound to be transmitted and reflected back to sound receiver 32 on first side of laundry 40, =2t₁)
d₁=distance from sound generator 30 to first side of laundry 40 (calculate from t₁)
t₂=time for transmitted sound to pass through laundry 40
d₂=distance through laundry 40
t₃=time for transmitted sound to pass through air on other side of laundry 40
d₃=distance from other side of laundry 40 to sound receiver 32 on other side of laundry 40

In short, in this first example the controller 22 operates the sound generator(s) 30 and processes the signals received from the sound receiver(s) 32 so as to obtain a measure of the speed of sound V_{L} in the laundry 40, and from that obtain an indication of the type of the laundry 40, specifically the fabric type of the laundry 40.

The speed of sound in air V_{A} may be obtained by the controller 22 in a number of ways. In one example, the machine 10 may have a temperature sensor and an air pressure sensor (not shown) which measure the ambient air temperature and pressure. A look-up table or the like may be provided in the data storage 24 so that the controller 22 can look up the speed of sound in air V_{A} corresponding to the measured air temperature and pressure. Alternatively or additionally, in another example the controller 22 can cause a calibration process to be carried out. For example, the sound generator 30 on one side of the machine 10 may be caused to emit a sound when no laundry item is present, and the time of receipt of that sound by the sound receiver 32 on the other side of the machine 10 provides the transit time t_{A} for the sound to pass through the air between the opposed sound generator 30 and sound receiver 32. As noted, the total distance d from the sound generator 30 to the sound receiver 32 on the other side of laundry 40 is known as this relates to the fixed, physical location of the sound generator 30 and sound receiver 32 in the machine 10. The controller 22 can therefore calculate the speed of sound in air V_{A} knowing t_{A}and d.

Then, as an item of laundry 40 is loaded into the machine 10, the controller 22 controls the sound generator 30 to generate sound and receives signals from the sound receiver 32 on the other side of the laundry 40 corresponding to the sound received by that sound receiver 32, and obtains therefrom the total time t_{T} for sound to travel from the sound generator 30, through the laundry 40 and to the sound receiver 32 on the other side of laundry 40. In this regard, the machine 10 may have some sensor, such as for example an optical sensor, etc., which detects when an item of laundry 40 is being loaded into the machine 10 and controls the sound generator 30 to emit sound at that time. Alternatively, the controller 22 may effectively operate continuously, causing the sound generator 30 to generate (pulses of) sound continuously and continuously operating on signals received from the sound receiver(s) 32.

In addition, the controller 22 receives signals from the sound receiver 32 that is on the same side of the laundry 40 as the first sound generator 30 and that is reflected by the exterior of the laundry 40. This sound has travelled twice the distance d₁ in a time 2t₁. The controller 22 obtains this total time 2t₁ from the time that sound is emitted by the first sound generator 30 and the time of receipt of the reflected sound by the sound receiver 32 that is on the same side of the laundry as the first sound generator 30. From this and knowing the speed of sound in air V_{A}, the controller 22 can calculate the distance d₁ from the sound generator 30 to the first side of laundry 40.

By a similar process using the second sound generator 30 and the sound receiver 32 that are both on the opposite side of the laundry 40 in this example, the controller 22 can calculate the distance d₃ from the second sound generator 30 to the second side of laundry 40.

Knowing the total distance d from the sound generator 30 to the sound receiver 32 on the other side of laundry 40, and now knowing d₁ and d₃, the controller 22 can simply calculate d₂, which is the distance that sound has travelled through the laundry item 40, i.e. the lateral extent of the item of laundry 40 (at least at that particular time instant). Moreover, the controller 22 can obtain the time t₂ for transmitted sound to pass through the laundry 40 from the total time t_{T} for sound to travel from the sound generator 30, through the laundry 40 and to the sound receiver 32 on the other side of laundry 40 and from t₁ and t₃. Knowing d₂ and t₂, the speed of sound V_{L} in the laundry 40 can be obtained as d₂/t₂.

In summary for this first example:

t_{T}=t₁+t₂+t₃

d=d₁+d₂+d₃=Vₐt₁+V_{L}t₂+Vₐt₃

→

V_{L}t₂=d−Vₐt₁−Vₐt₃

→

V_{L}=1/t₂ (d−Vₐt₁−Vₐt₃)

Having obtained the speed of sound V_{L} in the laundry 40, the controller 22 can then estimate the type of laundry 40, in particular the type of fabric of the laundry 40. For this, in an example the data storage 24 includes a look-up table that contains a correspondence between the speed of sound in materials, including for example materials that are commonly present in laundry items, and the type of material itself. In this regards, as is well known, the speed of sound is different in different solid materials depending on for example the stiffness of the solid (i.e. how resistant to compressibility that material is) and the density of the solid. In the case of materials used in laundry items, the stiffness of the solid and the density of the solid may differ 12 for the same basic material (e.g. cotton or wool) depending on how the material is woven or knitted or otherwise formed to make the item. The look-up table may therefore contain data relating the speed of sound through the material to the type of material for a number of different arrangements for each type of material.

In a second example, there is only one sound generator 30 and a first sound receiver 32 at one side of the laundry 40 and a second sound receiver 32 but no second sound generator at the other, opposite side of the laundry 40. This example requires somewhat more complex processing, but requires fewer sound generators and potentially simpler control of the generation of sound (as there is only one sound generator 30 to control).

Referring again to FIG. 2, as in the first example, the controller 22 receives signals from the first sound receiver 32 which is on the same side of the laundry 40 as the sound generator 30 and that is reflected by the exterior of the laundry 40. This sound has travelled twice the distance d₁ in a time 2t₁. The controller 22 obtains this total time 2t₁ from the time that sound is emitted by the sound generator 30 and the time of receipt of the sound by the first sound receiver 32 which is on the same side of the laundry as the sound generator 30. From this and knowing the speed of sound in air V_{A}, the controller 22 can calculate the distance d₁ from the sound generator 30 to the first side of laundry 40.

To obtain the time t₂ for transmitted sound to pass through laundry 40 in this example and referring to FIG. 2, it is observed that some of the sound that has passed into the laundry 40 from the sound generator 30 is reflected at the interior edge of the laundry 40 that is on the opposite side of the laundry 40 from the sound generator 30. This is indicated by the reference R in FIG. 2. Some sound is also transmitted through the edge of the laundry 40 that is on the opposite side of the laundry 40 from the sound generator 30, as indicated by the reference T in FIG. 2.

For the sound R that is internally reflected at the opposite edge of the laundry 40, this is received by the first sound receiver 32 that is on the same side of the laundry 40 as the sound generator 30 which generated that sound. The sound R that is internally reflected at the opposite edge of the laundry 40 and received by the first sound receiver 32 has travelled for a time t₁+t₂+t₂+t₁. On the other hand, the sound that is externally reflected by the first, neighbouring edge of the laundry 40 has travelled for a time 2t₁. Accordingly, the controller 22 can calculate the time t₂ by detecting the sound that is internally reflected at the opposite edge of the laundry 40 in addition to detecting the sound that is externally reflected at the first, neighbouring edge of the laundry 40. In addition, as before, the controller 22 knows the total time t_{T} for sound to travel from the sound generator 30, through the laundry 40 and to the second sound receiver 32 on the other side of laundry 40. The controller 22 can therefore calculate t₃.

Knowing the speed of sound in air V_{A} at the current time (as discussed above for the first example), knowing the total distance d from the sound generator 30 to the second sound receiver 32 on the other side of laundry 40, and now knowing t₁, t₂ and t₃, the controller 22 can again calculate the speed of sound V_{L} in the laundry 40 as above:

V_{L}=1/t₂(d−Vₐt₁−Vₐt₃)

The controller 22 may control the or each sound generator 30 to generate sound that has different properties at different times. For example, the sound generator 30 may be controlled to generate sound that has a different frequency or a different wave pattern (e.g. differently shaped pulses of sound) at different times. This can make it easier for the processing carried out by the controller 22 to determine which sound signal that has been received by a particular sound receiver 32 corresponds to which signal that was actually transmitted by the sound generator 30 (or transmitted by which sound generator 30 in the case that there are plural sound generators 30) as the controller 22 can match transmitted sounds with received sounds more easily. This in turn makes it easier for the processing carried out by the controller 22 to determine which received sound signal was reflected by which side of the laundry 40.

Further variations are possible, enabling for example more sophisticated processing and therefore better identification of the type of laundry 40, as well as other benefits.

For example, there may be several (i.e. more than two) sound receivers 32 located at several positions around the door casing of the machine 10. There may be several (i.e. more than two) sound generators 30 located at several positions around the door casing of the machine 10. This can be used to obtain a measure of the overall size of the item of laundry 40 as it is loaded into the machine 10 as the several sound generators 30 and/or sound receivers 32 can obtain a measurement of the extent of the laundry item 40 in a number of corresponding directions across or through the laundry item 40. This can be used to generate a three-dimensional image of the laundry item 40. From this, and knowing the type of material of the item of laundry 40, the controller 22 can estimate the weight of the item of laundry 40. In turn, the controller 22 can keep track of the total weight of laundry 40 without requiring specific weight measuring sensors to be provided in the machine 10. The controller 22 can cause an audible and/or visual alert to be provided to the user by the machine 10 if it determines that a maximum weight for the washing load has been reached.

In other examples, the controller 22 not only determines the time of reception of sound by the sound generator(s) 32, but also determines the amplitude of sound received by the sound generator(s) 32. From this, a better and more accurate determination of the specific type of material or fabric of the laundry item 40 can be obtained.

For example, the acoustic impedance Z of a solid in terms of the speed of sound V_{solid} in the solid and the density ρ of the solid is given by:

Z=ρ·V_{solid}

Acoustic impedance is normally a complex value but in the “far field”, the imaginary term disappears. The formula for the far field is:

L∞D²/4λ

where L defines the far field, D is the diameter or aperture width of the sound generator (such as a speaker or other transducer), and λ is wavelength of the sound signal. Accordingly, for distances further than around L from the sound generator, the acoustic impedance Z=ρ·v_{solid} is a real number. Thus, knowing the speed of sound v_{solid} in the solid and knowing the acoustic impedance Z of the solid, the density of the solid can be calculated.

The acoustic impedance Z of the solid, here the item of laundry 40, can be obtained from the amplitude of reflected sound signals reflected either at an external boundary or edge of the item of laundry or at an internal boundary or edge of the item of laundry. In particular, it is known that the reflection and transmission coefficients between two materials with different acoustic impedances Z₁, Z₂ are respectively:

K_{reflection}=(Z₁−Z₂)²/(Z₁+Z₂)²

Kₜᵣₐₙₛₘᵢₛₛᵢₒₙ=4Z₁Z₂/(Z₁+Z₂)²

Here, the two materials are air on the one hand and the item of laundry on the other hand. Accordingly, by measuring the amplitudes of signals received by the sound receivers 32 and that relate to reflected sound and transmitted sound respectively, the value for the acoustic impedance Z of the solid, here the item of laundry 40, can be calculated. From that and knowing the speed of sound v_{solid} in the item of laundry 40, the density ρ of the item of laundry 40 can be calculated by the controller 22. This in turn can be used to obtain a more accurate identification of the type of fabric or material of the item of laundry 40. For example, a look-up table stored in the data storage 24 may contain a correspondence between the speed of sound v_{solid} in materials and the density p of the material, including for example materials that are commonly present in laundry items, and the type of material itself; in this case, a greater number of types of fabric and material can be represented and can be discriminated by the method. Moreover, this example only requires as a minimum the use of a single sound generator 30 and a single sound receiver 32.

Nevertheless, additional sound generators 30 and/or sound receivers 32 may be provided and used as this can lead to more accurate identification of the type of laundry 40 and the shape and size of the laundry 40.

In an example, the wash program in the case of a washing machine or say the drying program in the case of a dryer can be automatically selected by the controller 22 depending on the fabric type(s) that has or have been identified. Alternatively or additionally, the controller 22 may cause a subset of available programs suitable for the fabric type(s) that has or have been identified to be offered to the user, so that the user only has to select from programs that have been identified as being suitable or appropriate for the identified laundry 40.

In an example, an error message be caused to be generated in the case of non-compatible fabrics types being identified. The user may then remove the non-compatible items of laundry prior to starting the machine 10.

In another example, an error message be caused to be generated in the case that the user selects a washing or drying program that is not compatible with or suitable for the identified type of laundry 40.

In an example, the data for the look-up table(s), such as for example fabric type and corresponding speed of sound in that fabric type, may be generated and loaded into the look-up table(s) at development time by for example the manufacturer actually loading the machine 10 with different fabric types, allowing the system to measure the values, and then entering the fabric type by hand to the system via an user interface. Alternatively, the machine 10 may be provided with a functionality that allows the end-user to carry out a similar process.

In another example, the end-user can enter new fabric types, which are not pre-configured or pre-stored in the data storage 24 or program of the controller 22, by loading the machine 10 with the specified fabric and entering the fabric type or related wash or dry program using an user interface.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), graphics processing units (GPUs), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

Reference is made herein to data storage for storing data. This may be provided by a single device or by plural devices. Suitable devices include for example a hard disk and non-volatile semiconductor memory (e.g. a solid-state drive or SSD).

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1. A washing and/or drying machine, the machine comprising:
a drum for receiving laundry to be washed and/or dried;
a sound generator for generating sound to be directed at laundry;
a sound receiver arranged to receive sound generated by the sound generator and that is reflected and/or transmitted by said laundry and to output corresponding output signals; and
a controller constructed and arranged to control the sound generator to generate sound, to receive output signals from the sound receiver, and to determine the laundry material in accordance with the acoustic properties of the laundry based on at least the output signals received from the sound receiver.

2. A machine according to claim 1, wherein the sound generator is arranged to direct sound at laundry as the laundry is loaded into the drum.

3. A machine according to claim 1, wherein the sound generator and the sound receiver are located in a door casing of the machine which defines the main entrance to the drum.

4. A machine according to claim 1, comprising a sound generator and a first sound receiver located at a first side of the machine and a second sound receiver located at a second side of the machine, the first sound receiver being arranged to receive sound that has been generated by the sound generator and reflected by an exterior surface of laundry located towards the first side of the machine, the second sound receiver being arranged to receive sound that has been generated by the sound generator and transmitted through said laundry.

5. A machine according to claim 4, wherein the first sound receiver is arranged to receive sound that has been generated by the sound generator and reflected by an interior surface of laundry located towards the second side of the machine.

6. A machine according to claim 4, comprising a second sound generator located at the second side of the machine, wherein the second sound receiver is arranged to receive sound that has been generated by the second sound generator and externally reflected in use by a second side of said laundry which is towards the second side of the machine, and wherein the controller is arranged to determine the laundry material from the speed of sound in the laundry as calculated from the time of flight and the speed of sound from the first sound receiver to the first side of said laundry, the time of flight and the speed of sound from the second sound receiver to the second side of said laundry, the time of flight of sound from the first or second sound generator to the second or first sound receiver respectively and the distance between said sound generator and said sound receiver.

7. A machine according to claim 1, wherein the sound receiver is arranged to provide a measure of the amplitude of received sound, and the controller is configured to determine the density of said laundry in accordance with the amplitude of received sound and the speed of sound in said laundry.

8. A machine according to claim 1, comprising data storage which stores data concerning different types of laundry material and acoustic properties of the different types of laundry material.

9. A machine according to claim 8, wherein the data concerning different types of laundry material and acoustic properties of the different types of laundry material comprises different densities of laundry material and the corresponding speed of sound in said laundry material.

10. A machine according to claim 1, the controller being configured to cause the machine to operate a program based at least in part on the determined laundry material.

11. A method of determining a type of laundry material, the method comprising:
directing sound at an item of laundry as the laundry is loaded into a washing and/or drying machine;
receiving sound that is transmitted and/or reflected by the item of laundry; and
determining the laundry material of the item of laundry in accordance with the acoustic properties of the laundry based on the received sound.

12. A method according to claim 11, wherein:
the directing sound comprises directing sound towards a first side of the item of laundry; and
the receiving sound comprises: receiving at the first side of the item of laundry sound that has been reflected by an exterior surface of laundry at the first side of the item laundry; and receiving at a second side of the item of laundry sound that has been transmitted through the laundry.

13. A method according to claim 12, wherein the receiving sound comprises receiving at the first side of the item of laundry sound that has been reflected by an interior surface of the laundry located towards the second side of the item of laundry.

14. A method according to claim 11, wherein the determining the laundry material of the item of laundry comprises determining the laundry material of the item of laundry based on the amplitude of received sound.

15. A method according to claim 11, wherein the acoustic properties of the laundry comprise the speed of sound in the laundry.
